(19) United States
(12) Patent Application Publication
(10) Pub. No.: US 2026/0003991 A1
(43) Pub. Date: Jan. 1, 2026

(54) POPULATION-STRUCTURE STATISTICS FOR PRIVACY-PRESERVING DATA ANALYSIS

(71) Applicants: CASE WESTERN RESERVE UNIVERSITY, Cleveland, OH (US); RUTGERS UNIVERSITY OFFICE FOR RESEARCH, Piscataway, NJ (US); THE BOARD OF REGENTS OF THE UNIVERSITY OF TEXAS SYSTEM, Austin, TX (US)

(72) Inventors: Erman Ayday, Cleveland, OH (US); Jaideep Vaidya, East Brunswick, NJ (US); Xiaoqian Jiang, Houston, TX (US)

(21) Appl. No.: 19/255,048

(22) Filed: Jun. 30, 2025

Related U.S. Application Data
(60) Provisional application No. 63/665,496, filed on Jun. 28, 2024.

(51) Int. Cl. G06F 21/62; G06F 18/23

(52) U.S. Cl. CPC G06F 21/6218; G06F 18/23

(57) ABSTRACT

An example method can include applying, on or by the first computer, a trained principal component analysis (PCA) model to the samples of a first dataset to provide a PCA output. The method can also include generating metadata based on the PCA output, sending the metadata from the first computer to a second computer. The method can also include receiving cluster data at the first computer, in which the cluster data is determined by second computer to define a measure of relatedness among the samples in at least the first dataset based on the metadata from the first computer and other metadata from at least one other computer.

### RELATED APPLICATION

This application claims priority from U.S. Provisional Application No. 63/665,496, filed Jun. 28, 2024, which is incorporated herein by reference in its entirety.

### GOVERNMENT FUNDING

This invention was made with government support under LM013429 and LM014520, awarded by the National Institutes of Health. The government has certain rights in the invention.

### TECHNICAL FIELD

This disclosure relates to systems and methods of preserving privacy across datasets, such as using population-structure statistics to identify population structures for collaborative research.

### BACKGROUND

When various types of data are shared between two or more entities, there may be a need to preserve the privacy of data being shared, such as to conceal or obfuscate the identity or source of such data. For example, the use of genomic data in collaborative studies can have privacy implications, as it includes information about an individual's phenotype, ethnicity, family memberships, and disease conditions, which might be highly sensitive to the study participants. One often overlooked step in privacy-preserving collaborative studies is the identification of samples (records) that are to be included and/or filtered for the collaborative study. For example, population structures (e.g., genetic differences in individuals due to subpopulations) can be a main aspect of quality control in collaborative genomic studies. The identification of such samples (records) is fundamental to ensure that the results of the collaborative study are based on high quality data.

### SUMMARY

This disclosure relates to systems and methods of preserving privacy across datasets, such as by determining relatedness of samples in the datasets.

A described example relates to a method that includes generating, on or by a first computer, first metadata based on applying a trained model to a plurality of samples stored in a first dataset, in which each sample of the plurality of samples stored in the first dataset includes a plurality of data units. The first metadata can include features having a reduced dimensionality from the first dataset and representing variations and/or patterns in the first dataset according to the trained model. The method can also include generating, on or by a second computer, second metadata based on applying the trained model to a plurality of samples stored in a second dataset, in which each sample of the plurality of samples stored in the second dataset includes a plurality of data units and the second metadata includes features having a reduced dimensionality from the second dataset and representing variations and/or patterns in the second dataset according to the trained model. The method can also include sending the first metadata to a third computer through a first communications link and sending the second metadata to the third computer through a second communications link. The method can also include combining, by the third computer, the first metadata and the second metadata to provide aggregate metadata representing samples of the first dataset and the second dataset. The method can also include classifying, by the third computer, the samples into respective clusters based on the aggregate metadata and providing cluster data identifying respective samples in each of the respective clusters. The cluster data can be sent to each of the first computer and the second computer.

Another described example includes a method that includes selecting, on or by a first computer, a subset of data units in each of a plurality of samples stored in a first dataset, in which each sample of the plurality of samples stored in the first dataset includes a respective plurality of data units. The method can also include applying, on or by the first computer, a trained principal component analysis (PCA) model to the selected subset of data units in the samples of the first dataset to provide a PCA output. The method can also include generating metadata based on the PCA output and sending the metadata from the first computer to a second computer. The method can also include receiving cluster data at the first computer, in which the cluster data is determined by second computer to define a measure of relatedness among the samples in at least the first dataset based on the metadata from the first computer and other metadata from at least one other computer, and the measure of relatedness among the samples quantifies a similarity between samples based on the subset of data units for samples in the first dataset and a subset of data units for samples in at least one other dataset associated with the at least one other computer. The method can also include removing or retaining a subset of samples from the first dataset based on the cluster data to provide an updated first dataset.

Another described example provides a system that includes a first computer that includes non-transitory memory to store instructions and data, in which the data comprises a first dataset that includes a plurality of samples, each sample including a plurality of data units. The first computer can also include one or more processors coupled to the memory, in which the instructions are executable by the one or more processors. The instructions can include metadata generator code to apply a trained principal component analysis (PCA) model to a selected subset of data units in the samples of the first dataset to provide a PCA output and generate first metadata based on the PCA output. A second computer can include non-transitory memory to store second instructions and data, in which the data comprises a first dataset that includes a plurality of samples, each sample including a plurality of data units. The second computer can also include one or more processors coupled to the memory, in which the second instructions are executable by the one or more processors thereof. The second instructions can include combiner code to combine the first metadata and at least second metadata, which is associated with a second dataset, to provide aggregate metadata corresponding to samples of the first dataset and the second dataset. The second instruction can also include clustering code to classify the samples of the first dataset and the second dataset into respective clusters based on the aggregate metadata and provide cluster data identifying respective samples in each of the respective clusters. The second instructions further can include code to send the cluster data to at least the first computer.

### BRIEF DESCRIPTION OF THE DRAWINGS

FIG. 1 is a block diagram of an example of a system to implement population stratification within a privacy-preserving framework.

FIG. 2 is a block diagram of an example subsystem to generate metadata.

FIG. 3 depicts a workflow diagram for an example privacy preserving system.

FIGS. 4A, 4B, 4C, and 4D depict plots of combined PCA outputs generated for a PCA model trained based on datasets having different populations.

FIGS. 5A, 5B, and 5C are plots depicting precision, recall, and power, respectively, for an example privacy-preserving framework.

FIG. 6 is a flow diagram depicting an example method to preserve privacy for collaborative data analysis.

### DETAILED DESCRIPTION

This disclosure relates to systems and methods of preserving privacy across datasets, such as using population-structure statistics to identify population structures for collaborative data analysis

As described herein, the systems and methods can be implemented within a shared privacy-preserving computing framework (e.g., a federated data system). The framework can enable collaboration between two or more entities (e.g., each having a respective computer) and a shared computing resource (e.g., a server, a computing cloud, or other computer). For example, each of the entities can be individuals (e.g., researchers or other data analysts), computers being used by or under the control of the respective individuals, or both the individuals and their respective computers. As described herein, the term computer can refer to any device or combination of devices including one or more processors and non-transitory memory to store data and executable instructions. In the shared framework, each entity can operate independently and include a respective dataset that includes a set of samples (e.g., data records), such as corresponding to samples of genetic information of respective individuals, each having a respective plurality of data units (e.g., single nucleotide polymorphisms (SNPs)).

As described herein, each of the entities can utilize a trained model (e.g., a common model trained to characterize population structures). For example, the shared computing resource (e.g., server) can initially train the model based on a publicly available genomic dataset that contains individuals of various populations. The publicly available genomic dataset can be any dataset sufficient to enable the trained model to capture population clusters for the samples in the first dataset and the at least one other dataset. As an example, the model can be a principal component analysis (PCA) model trained using the publicly available genomic dataset to identify population stratification from such dataset. The trained model can be sent to the entities (e.g., downloaded to respective computers used by the respective researchers) and the entities can compute respective model outputs by applying this trained model to their local datasets. As a result, the model output for each researcher represents a projection of individuals in their datasets with respect to the trained model. For example, the model output for each researcher can include features (e.g., principal components for a PCA model) having a reduced dimensionality compared to the samples in the dataset and representing variations and/or patterns in the dataset according to the trained model (e.g., trained PCA model).

In some examples, to increase privacy of the records in their local datasets, entities can add noise (e.g., Laplacian noise) to obfuscate each sample in the model output. Identifiers (IDs) for each sample, which contains the model outputs (e.g., principal components for a PCA model), further can be obfuscated by a data obfuscation technique, such as hashing, encryption, data masking, salting, and the like. The resulting metadata for each researcher, which can include noise-introduced, model outputs for each of the samples and obfuscated IDs of each sample, can be sent to the shared computing resource (e.g., server). For example, each entity can send the metadata to the shared resource through a respective communications link. The shared computing resource can aggregate the metadata (e.g., PCA outputs) for the samples from the collaborating entities and identify the population substructure (population stratification). For example, the shared computing resource can classify the samples into respective clusters based on the aggregate metadata and provide cluster data identifying which respective samples reside in each of the respective clusters. The shared computing resource can then send back to each researcher the cluster data and obfuscated sample IDs to specify which population cluster each sample belongs to. Each of the entities can analyze the samples in their dataset based on the population stratification specified for respective samples in the cluster data.

Compared to other approaches, the systems and methods described herein can achieve high accuracy, precision, and recall in identifying genetic differences among collaborators' datasets while preserving the privacy of the research participants. As a result, the systems and methods described herein can enable researchers to conduct collaborative research with high quality data while ensuring that the privacy of the research participants is preserved. Depending on the study the researchers are conducting, the collaborating researchers may decide to keep only the individuals that belong to the largest population in their combined dataset or the ones that belong to the smallest population.

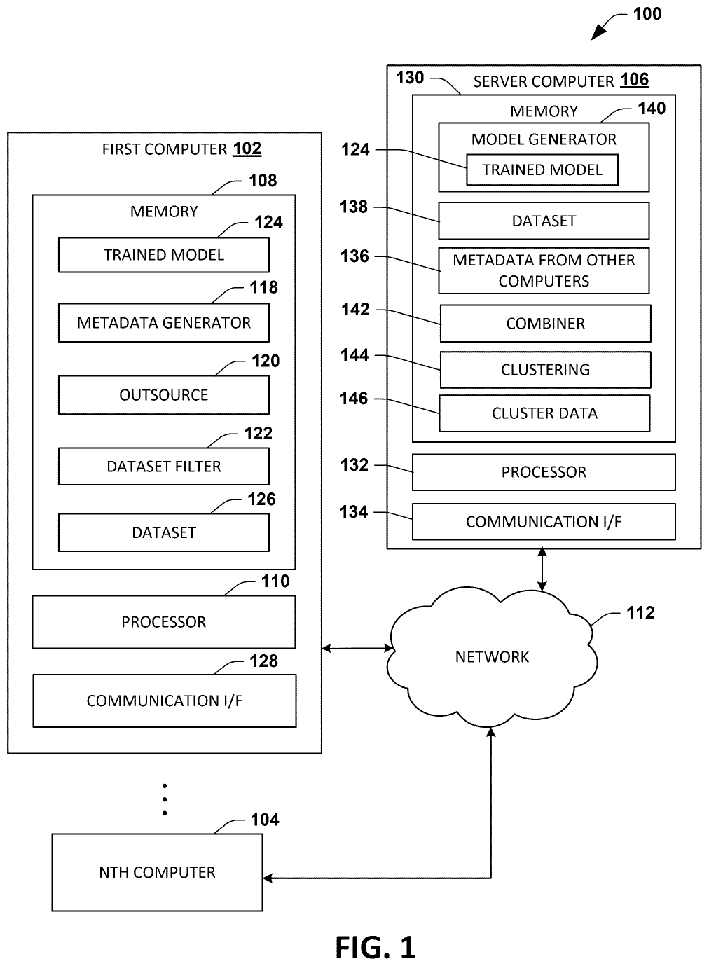

FIG. 1 depicts an example of a system 100 to enable privacy preservation within a shared computing framework, such as a federated system. The system 100 includes a number of computers 102 and 104, shown as the first computer and the Nth computer, where N is a positive integer greater than one denoting the number of computers. Each of the N computers 102, 104 can be associated with (or controlled by) one or more users, such as researchers or other data analysts. The system 100 also includes a server computer 106 (also referred to herein as a server). The server 106 can be implemented or controlled by a third party (e.g., a shared computing resource) that has sufficient computation power to enable collaborative data analysis and studies based on data shared by two more users (e.g., via computers 102-104). Each of the computers 102, 104, and 106 can be coupled to each other through one or more communication links, shown as including a network 112. The network 112 can include hardware, software, and/or firmware to enable communications of data between any or all of the computers 102, 104, 106 through one or more physical (e.g., wired or optical) and/or wireless communication links, such a can form part of one or more local area networks, wide area networks, etc.

As an example, the first computer 102 includes memory 108, which can include one or more non-transitory machine-readable media to store data and executable instructions (e.g., program code). The computer 102 can also include one or more processors 110, each of which can include one or more processing cores, to access the memory 108 and execute corresponding instructions. In the example of FIG. 1, the instructions in the memory 108 include program code (e.g., methods or functions), including a metadata generator module (also referred to as metadata generator) 118, an outsource module 120, and a data filter 122. The memory 108 also includes a trained model 124 and a dataset 126. The dataset 126 can include a multitude of data samples, which can be processed and analyzed based on the trained model 124 and execution of one or more of the modules 118, 120, and 122.

The trained model 124, dataset 126 and/or modules 118, 120, and 122 can reside locally on the computer 102, be implemented remotely through a set of program interfaces on another computer (e.g., a cloud-based computing system), or be implemented in a distributed computing architecture that includes the computer 102 and one or more remote computers. The dataset 126 in each of the N computers 102, 104 can be separate and independent data, which can be of a confidential and/or private nature, such as genomic information for a plurality of subjects. As used herein, a subject can refer to any individual (e.g., human or other animal) for which associated data has been acquired and stored in a corresponding dataset. The dataset 126 can store the samples according to various types of data structures (e.g., linked lists, records, arrays, hash tables, trees, and the like), which can vary depending on the type of data. For example, the dataset 126 includes a plurality of data samples for respective subjects, in which each sample includes a plurality of data units describing genetic variations (e.g., SNPs) for each of the subjects. In some examples, the value of each SNP in the dataset 126 can be represented as 0, 1, or 2 depending on the number of minor alleles the respective SNP contains.

The computer 102 can also include one or more communication interface 128 configured to enable communication between the first computer and the server computer 106 as well as, in certain examples, between the first computer and any of the other N−1 computers 104. For example, the communications interface 128 can include a wireless communications network device configured to communicate data through a wireless network (e.g., network 112), such as a Wi-Fi, Bluetooth, or a cellular data link. Also, or as an alternative, the communications interface 128 can include a physical communications network device configured to communicate data through a wired or optical network (e.g., network 112), such as Ethernet, fiber channel, or the like. Also, or as an alternative, the communications interface 128 can be configured to implement secure connection (e.g., encrypted data communications) through the network 112.

The server computer 106 includes memory 130, which can include one or more non-transitory machine-readable media, to store data and executable instructions (e.g., program code). The server computer 106 can also include one or more processors 132, each of which can include one or more processing cores, to access the memory 130 and execute corresponding instructions, which can be based on data received from one or more of the computers 102, 104. The server computer 106 also includes one or more communication interfaces 134 configured to enable communication with the first computer 102 and one or more other computers 104.

In the example of FIG. 1, the memory 130 can store data received from one or more other computers 102, 104, including metadata 136 from such other computers. The memory 130 can also store a dataset (e.g., also referred to herein as D^{s}) 138, such as a public genomic dataset consisting of various populations. The memory 130 further can include program code (e.g., modules executable by the processor 132) including a model generator 140, a combiner module 142, and a clustering module 144. The model generator 140 can be configured to generate the trained model 124, which is utilized by each of the computers 102 and 104, based on the dataset 138. The dataset 138, which is used to generate the trained model 124 includes sufficient samples across a number of populations (e.g., p different populations) sufficient to enable the trained model 124 to capture population clusters for the samples in the first dataset and the at least one other dataset. However, the dataset 138 does not necessarily include the populations in the local datasets 126 of the collaborating entities. The number of populations (the p value) in the dataset 138 can affect the accuracy of the population substructure identification based on the trained model 124. As described herein, for example, trained model 124 can be provided as a file or other data structure that includes a set of learned parameters, weights, and structures that define how the trained model 124 processes the input dataset 126 to produce a corresponding model output.

For sake of brevity details of each of the other N−1 computers 104 have been omitted. In the example system 100 of FIG. 1, it is to be understood that each of the other N−1 computers 104 can be configured in a similar manner to the first computer 102 (e.g., including executable instructions and a dataset) to enable operation in the shared computing framework provided by the system 100. Different computing architectures can be used to implement any one or more of the computers 102, 104, 106 in other examples. As described herein, instead of outsourcing information all at once, each user (e.g., researcher or data analyst) breaks down the metadata and outsources a small subset of metadata for each of a plurality of iterations.

By way of example, the metadata generator 118 (e.g., instructions executable by the processor 110) is configured to apply the trained model 124 to the dataset 126 and provide a corresponding model output. The model outputs can include features representing variations and/or patterns in the dataset 126 according to the trained model 124. The features in the model output for respective samples can also have a reduced dimensionality from the samples in the dataset 126. In some examples, the trained model 124 is a trained PCA model, and features of the PCA model output define principal components, which can be defined based on a set of eigenvectors having largest eigenvalues. The number of principal components (referred to herein as d) that are obtained responsive to applying the trained PCA model 124 to the dataset 126 can be adjustable, which can be defined for the model generator 140 in response to a user input. The number of principal components d further defines a dimensionality of the model output for each of the samples in the dataset 126. The model output (e.g., PCA output) thus can include coordinates in a d-dimensional spatial domain, as defined by the trained model, and an identifier (ID) for each of the samples in the dataset 126.

In some examples, each entity (e.g., researcher) that is collaborating through the server computer 106 can locally generate (by instructions executing on its computer 102, 104) respective metadata for a selected subset (e.g., a proper subset) of data units for the samples stored in the respective datasets 126. For example, the selected subset of data units (e.g., an agreed upon set of SNPs) can be agreed to in advance as part of the corresponding collaboration to limit the dataset 126 to the selected subset of data units. The selected subset of data units can be any number of the data units (e.g., ranging from 1 data unit to the entire set of data units). The metadata generator 118 can apply the trained model 124 to the selected subset of data units, such as to be used for the collaboration.

The metadata generator 118 is further configured to provide metadata (referred to herein as Cⁱ, where i indicates the entity/researcher/dataset for which the metadata has been generated) for the samples (or at least a portion thereof) stored in the dataset 126 based on the model output (e.g., PCA output). In an example, the metadata generator 118 can add noise to each of the features of the PCA output (e.g., resulting in noisy model coordinates). The noise added to each model output feature can be same or different, such as described herein. For the example of the trained model 124 being a trained PCA model that provides a corresponding PCA output, the trained PCA model can include a sensitivity for each of the principal components, and the noise can be applied separately to each dimension of the PCA output based on the respective sensitivity. Also, or alternatively, the metadata generator 118 can be configured to obfuscate the unique identifier (ID) for each of the samples of the first dataset to obfuscate the real identities of the participants (e.g., users) that provided the samples in the dataset 126. For example, the ID in the resulting metadata Cⁱ can be an obfuscated ID (e.g., by hashing or another form of data obfuscation implemented by the model generator).

The outsource module 120 (e.g., instructions executable by the processor 110) is configured to send the metadata from the computer 102 to the server computer 106 through a corresponding communications link, including network 112. For example, the outsource module 120 can instruct the communication interface 128 to send the metadata over a secure communications link to the server computer 106. In some examples, the systems and methods described herein can implement secure multi-party computation (secure-MPC) protocols, such as ABY³, Falcon, Function Secret Sharing (FSS), SPDZ, etc.

The server computer 106 can receive the metadata through its communication interface 134 and store the metadata from two or more collaborating computers 102, 104 in memory 130, shown at metadata 136, for further processing as described herein.

The combiner 142 (e.g., instructions executable by the processor 132) is configured to combine the metadata 136 received from the N computers involved in the collaborative analysis. The combiner 142 can thus provide aggregate metadata associated with samples of the data, which can include IDs and coordinates provided in the metadata received from the N computers 102, 104 that are collaborating. The aggregate metadata can be plotted in a corresponding spatial domain based on the dimensionality d of the trained model 124.

The clustering module 144 can be configured to classify the samples into respective clusters based on the aggregate metadata and provide corresponding cluster data 146 identifying respective samples in each of the respective clusters. The respective clusters can define population clusters (e.g., identifying a population stratification) for individuals represented by the samples in the datasets associated with the collaborating entities. The cluster data 146 can define a measure of relatedness for the samples represented by the combined metadata 136 (e.g., provided by the N collaborating computers 102-104) based on the trained model used to generate the respective metadata.

As an example, the cluster data 146 can include an identifier (e.g., a unique name, descriptor, label, etc.) for each of the identified population clusters. The cluster data 146 can be associated with at least some of the samples in the collaborating datasets. For example, respective cluster data 146 can be added to the metadata (e.g., Cⁱ) for each sample, such as to specify one or more population clusters to which each respective sample belongs. Alternatively, the respective cluster data 146 can include or be associated (e.g., linked) to the ID for each sample represented in the combined metadata 136. Various approaches can be implemented to provide cluster descriptors to indicate which cluster each of the respective samples belongs to. Also, in some examples, a given sample can be classified in one cluster or in more than one cluster, such that more than one cluster identifier can be associated with the given sample.

The server computer 106 further includes instructions configured to return the cluster data 146 to each of the collaborating N computers 102-104 that provided the metadata 136. The computer 102, 104 for each collaborator can receive and process the cluster data 146 to enable further analysis based on the identified population substructure. For example, each of the collaborating entity computers can include a data filter 122 configured to remove or retain a subset of samples from the dataset 126 based on the cluster data 146 to provide a filtered dataset. The filtered dataset can include samples having membership in the clusters specified by the cluster data. Also, or alternatively, the filtered dataset can include samples excluding samples that belong to the clusters identified by the cluster data 146. As a result, each entity (e.g., researcher) is able to recover the results as computed on the whole metadata (or a larger subset of metadata) based on the cluster data 146 returned at each iteration.

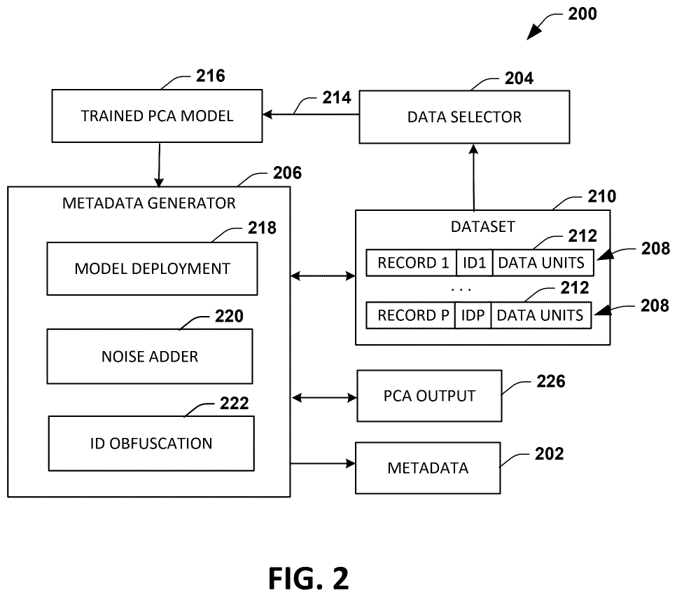

FIG. 2 is a block diagram depicting an example subsystem 200 that can be implemented by an entity to generate metadata 202. The subsystem 200 can be implemented as part of a privacy preserving system (e.g., the system 100 of FIG. 1). Accordingly, the description of FIG. 2 can also refer to certain aspects of FIG. 1. An instance of the subsystem 200 can be implemented by each of the N computers 102-104.

As shown in FIG. 2, the subsystem 200 can include a data selector 204 and a metadata generator 206. The data selector 204 (e.g., instructions executable by a processor) is configured to select a proper subset of the data units for samples (also referred to herein as records) 208 stored in a dataset 210. In the example of FIG. 2, the dataset 210 includes P records 208, where P is a positive integer denoting the number of samples in the data set. Each of the records 208 in the dataset 210 thus can include an ID (shown as ID1 through IDP) to uniquely identify each sample and a plurality of data units 212. For example, each of the records 208 can represent a sample of data for a respective individual (e.g., subject), such as genomic data, in which each sample of genomic data includes a number of data units, such as representing SNPs. The SNPs may reside within coding sequences of genes, non-coding regions of genes, or in intergenic regions (e.g., regions between genes). Other types and configurations of data can be used as data units in the records 208 in other examples.

The data selector 204 enables synchronization of data units 212 between collaborators for further analysis. The data selector 204 can operate to identify which data units (e.g., SNPs) are to be included in or excluded from use in generating the metadata 202. For example, the data selector 204 can be configured to enable collaboration between users (e.g., at respective computers 102, 104) by specifying a proper subset of the data units 212 for the records 208 stored in the dataset 210. As described herein, each of the selected data units 212 and its ID can be stored in memory (e.g., memory 108) and used for generating metadata for the samples 208. In some examples, a user can interact with a collaboration interface (e.g., a graphical user interface) to control the data selector 204 through one or more input devices (not shown, e.g., a keyboard, a mouse, a touchscreen, a gesture control device, etc.), which can be part of or external to the computer 102, 104. The collaborating users can agree on which data units to include and generate the selected subset of data units 212 independently. Also, or alternatively, control information can be exchanged between the users to enable selection of the selected subset of data units 212 for use by the metadata generator 206 in generating the metadata 202.

The metadata generator 206 (e.g., metadata generator 118) is configured to generate the metadata 202 by applying a trained PCA model (also referred to as M^{s}) 216 to the samples 208 in the local dataset 210. In some examples, data units of the samples 208 can include a selected subset of the data units, such as defined by the data selector 204, which is used for generating the metadata 202. In the example of FIG. 2, the metadata generator 206 includes a model deployment module 218, noise adder module (also referred to as a noise adder) 220, and an ID obfuscation module 222, which cooperate to generate the metadata 202 based on the trained PCA model 216.

As described herein, the trained PCA model 216 can be generated by a server (e.g., by model generator 140 on computer 106) from a large dataset, such as a publicly available genomic dataset (referred to herein a D^{s}). As a further example, suppose a matrix Z (e.g., defining D^{s}) has I observations (records), J variables, and rank L, where L is the minimum number of variables that describes I observations (or the minimum number of observations that can be described by J variables). To train the PCA model (also referred to as M^{s}) 216 on Z, and as a result, compute its components, the model generator 140 can use singular value decomposition (SVD) with Z=PΔQ^{T}, where P is the I×L matrix of left singular vectors, Q is the J×L matrix of right singular vectors, and D is the diagonal matrix of singular values. The new data points of any observation converted by the fitted principal components (i.e. trained PCA model 124) can be referred to herein as factor scores, denoted as F. F can be defined as the I×L matrix obtained as F=PΔ, or F=PΔQ^{T}Q=ZQ since Z=PDQ^{T}. The factor scores F can indicate the position of a data point in relation to the principal components (e.g., features) of the PCA output. The matrix Q (e.g., defined as components in scikit-learn machine learning library at https://scikit-learn.org) can represent a projection matrix that transforms not only the observations in Z but also new or supplementary observations Zₛᵤₚ (that are not in Z) into factor scores. The factor scores F for supplementary observations are obtained as

$${F}_{sup}^{T} = {Z}_{sup}^{T} Q .$$

Thus, the trained PCA model M^{s} 216 can include the number of principal components (d dimensions) and the matrix Q which contains the principal components (eigenvectors). In some examples, such as described herein, the trained PCA model 216 can also include a sensitivity parameter.

By way of example, the model deployment module 218 (e.g., instructions executable by the processor 110) is configured to apply the trained PCA model 216 to the dataset 210 (e.g., for a selected subset of the data units 212) and provide a corresponding PCA output 226. The model deployment module 218 can load the trained PCA model 216 from its stored representation and, if needed, implement preprocessing on the dataset 210 to ensure it is in the correct format for the model 216. The model deployment module 218 further can apply the trained PCA model 216 to the dataset 210 and generate the corresponding PCA output 226. The PCA output 226 can include features representing variations and/or patterns in the dataset 126 according to the trained model 216. The features for respective samples 208 can also have a reduced dimensionality from the samples 208 in the dataset 210.

In the example of FIG. 2, the features of the PCA model output 226 define principal components, which can be defined based on a set of eigenvectors having largest eigenvalues. The number of principal components (referred to as d) in the PCA output 226, which are obtained responsive to applying the trained PCA model 216 to the dataset 210, can be modified. For example, the number of principal components d can be set for the model generator (e.g., model generator 140) in response to a user input. The number of principal components d further defines a dimensionality of the PCA model 216 and resulting PCA output 226. While the example of FIG. 2 is described in the context of using a trained PCA model 216 to characterize population structure statistics, other types of models can be used in other examples.

As yet a further example, the dataset 210 for entity i (referred to as Dⁱ) has nⁱ samples 208, each having mⁱ data units 212 (e.g., mⁱ SNPs in Dⁱ), and hence mⁱ dimensions. The model deployment module 218 can apply the trained PCA model 216 to transform (e.g., project) the local dataset 210 to a reduced dimensionality (e.g., d dimensions) compared to the original dimensionality mⁱ of the dataset 210. For example, the data points (e.g., the samples 208 in the local dataset 210) can be reduced to d dimensions by computing the dot product with the eigenvectors in matrix Q. The number of principal components d can be 2 or more and can be adjustable according to application requirements, such as described herein. The model deployment module 218 can provide the PCA output 226 (also referred to as Oⁱ) for each of the nⁱ samples

$${O}^{i} = \{ {O}_{1}^{i} , … {O}_{j}^{i} , … {O}_{n}^{i} \} ,$$

where nⁱ represents the number of samples 208 in the dataset 210 (Dⁱ) for a given entity or researcher i. For example,

$${O}^{i} = \{ {x}_{j}^{i} , {y}_{j}^{i} \} ,$$

where

$${x}_{j}^{i} and {y}_{j}^{i}$$

represent the x and y coordinates (values of principal components 1 and 2, for d=2) of sample j's PCA output 226. As described, the PCA model 216 can have any number of dimensions d.

To further increase the privacy of the participating individuals (samples), such as against membership inference attacks, the noise adder module 220 (e.g., instructions executable by processor 110) is configured to introduce noise to each of the features (e.g., coordinates) of the PCA output 226 and provide the resulting output as the metadata 202 (e.g., resulting in noisy PCA coordinates). The noise added to each model output feature can be same or different, such as described herein. In some examples, the trained PCA model 216 can include a sensitivity parameter that has been determined (e.g., by model generator 140) for each of the principal components, and the noise can be applied separately to each dimension of the PCA output 226 based on the respective sensitivity parameters.

As a further example, the noise adder module 220 can add Laplacian noise locally to achieve ϵ-LDP (local differential privacy). LDP is a variant of DP (differential privacy) with a distributed architecture and provides strong guarantees for each individual's privacy. DP incorporates a centralized trusted party that has access to the raw data. In contrast, LDP uses each user's local dataset to perturb it and then sends it to a data collector. By definition, an algorithm A satisfies ϵ-LDP, if for any two user's private data points a₁ & a₂ and output b:

$$Pr [ A ( {a}_{1} ) = b ] \leq {e}^{′} Pr [ A ( {a}_{2} ) = b ] , \qquad Eq . 1$$

where ϵ is the privacy parameter.

One way to achieve ϵ-LDP is to add noise to each data point. The main challenge is to determine the amount of noise to add to achieve LDP, while still maintaining a good level of utility. Several different mechanisms have been developed in the DP field to solve this problem, one example of which is the Laplacian mechanism. For any numerical function ƒ(x): [symbol] → [symbol] , F(X) satisfies ϵ-LDP if noise adder 220 adds Laplacian noise as follows:

$$F ( x ) = f ( x ) + Lap ( \frac{s}{ϵ} ) , \qquad Eq . 2$$

where s is the sensitivity of the function ƒ (e.g., determined by model generator 140).

Sensitivity captures the maximum amount of change that a single data point can cause in the worst case to the output of the function ƒ. As an example, the noise adder 220 can use the l₁ sensitivity to add Laplacian noise for the respective principle component. For example, by definition the sensitivity,

$$s = {max}_{x , {x}^{′} ∈ ℝ} ‖ f ( x ) - f ( {x}^{′} ) ‖ .$$

Additionally, Lap(λ), where

$$λ = \frac{s}{ϵ} ,$$

denotes sampling from a Laplace distribution with scale k and with a probability density function:

$$pdf ( x \vert μ , λ ) = \frac{1}{2 λ} exp ( - \frac{\vert x - μ \vert}{λ} ) , \qquad Eq . 3$$

where 1 is a location parameter (1¼ 0 to have a symmetric distribution).

The noise adder module 220 can add noise to the first principal component of a data point as follows:

$${X}_{j}^{i} = {x}_{j}^{i} + Lap ( \frac{{s}_{1}}{ϵ} ) ,$$

where s₁ represents the sensitivity for the first principle component, and E represents the privacy parameter. As mentioned, the Laplace mechanism can be applied separately to each dimension of the PCA output, and the server provides the sensitivity value for each dimension, such as described herein. Further considering that the noise addition for each dimension can be independent, the privacy budget for each dimension is ϵ/2 (for d=2) and the total privacy budget is ϵ. Other numbers of dimensions d can be used in other examples, as described herein.

In some examples, the ID obfuscation module 222 (e.g., instructions executable by processor 110) is configured to obfuscate the unique identifier (ID) for each of the n′ samples 208 in the PCA output 226 to obfuscate the real identities of the participants (e.g., users) that provided the samples in the dataset 126. The ID obfuscation module 222 can implement the ID obfuscation before or after noise has been introduced to the PCA output 226. In an example, the ID obfuscation module 222 is implemented as a hash function configured to hash the IDs of the samples 208 to obfuscate the real identities of the participants from the server. In other examples, the ID obfuscation module 222 can implement other data obfuscation techniques, such as encryption, data masking, salting, and the like. For example, the ID in the resulting metadata Cⁱ can be an obfuscated ID.

The resulting metadata 202 (e.g., to which noise has been introduced and IDs have been obfuscated) can be stored in memory and sent to the server for additional processing, as described herein. For example, the metadata 202 can be represented as

$${C}^{i} = \{ {C}_{1}^{i} , … {C}_{j}^{i} , … {C}_{n}^{i} \} ,$$

where as

$${C}_{j}^{i} = \{ {X}_{j}^{i} , {Y}_{j}^{i} , {ID}_{j}^{i} \} , {ID}_{j}^{i}$$

denotes the ID of the sample j in the dataset 210 (Dⁱ), and Xⱼⁱ, Yⱼⁱ represent the respective PCA coordinates for the sample j. For example, the IDs in the resulting metadata Cⁱ can be obfuscated. Also, or alternatively, the PCA coordinates in the resulting metadata Cⁱ can be noisy PCA coordinates.

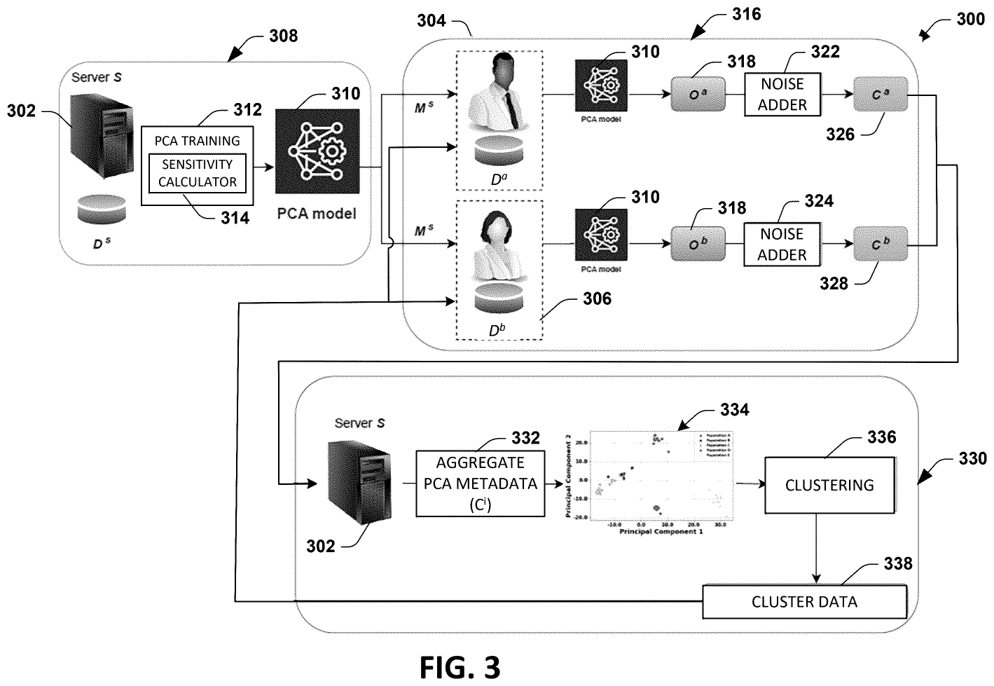

FIG. 3 depicts a workflow diagram 300 showing an example overall framework that can be used to implement an example privacy preserving system or method, which can be used by researchers for analyzing genomic data. As described herein, the systems and methods described herein are applicable to other data domains. The workflow diagram can implement the systems 100 and 200 of FIGS. 1 and 2. Accordingly, the description of FIG. 3 can also refer to certain aspects of FIGS. 1 and 2.

In the example of FIG. 3, the workflow diagram 300 includes a server 302 (e.g., server computer 106) and two more researchers, each having a respective computer 304 and 306 (e.g., computers 102 and 104). The workflow diagram 300 includes three main stages. A first stage 308 includes generating a trained model 310 (e.g., a PCA model). For example, the server 302 includes a model generator 312 (e.g., model generator 140) configured to train the PCA model 310 using an available dataset Ds. For example, the model generator 312 can be configured to standardize the data in the dataset Ds. The model generator 312 can then calculate the covariance matrix, find the eigenvalues and eigenvectors, select the top components based on the highest eigenvalues, and project the data onto these components to reduce its dimensionality, such as according to the desired dimensionality d, and provide the PCA model 310 In some example, the model generator 312 can also include a sensitivity calculator 314 configured to compute sensitivity parameters for respective features of the model. As mentioned, the sensitivity can be computed as the difference between the maximum and minimum values of each principal component in the PCA model 310. The server 302 is further configured to send the trained model (M^{s}) 310 along with the sensitivity parameters to each researcher computer 304 and 306.

In another stage 316 of the workflow diagram 300, respective computers 304 and 306 of each of the researchers Rⁱ uses the trained PCA model 310 to transform their original local dataset (e.g., Dⁱ) 305 and 307, respectively, to provide PCA outputs (e.g., Oⁱ) 318 and 320. The computers 304 and 306 can also include a respective noise adder module 322 and 324 to add noise (e.g., Laplacian noise) to PCA output data Oⁱ 318 and 320, such as to achieve ϵ-LDP and obtain corresponding metadata (e.g., Cⁱ) 326 and 328, as described herein. The respective computers 304 and 306 of each of the researchers Rⁱ further can obfuscate IDs in the metadata. Respective computers 304 and 306 of each of the researchers Rⁱ can then send the resulting metadata Cⁱ back to the server 302 for further processing as described herein. In some examples, a metadata generator of each respective computer 304, 306 is configured to generate metadata 326, 328 based on selected data units of the datasets 305, 307 (e.g., selected by data selector module 204).

In yet another stage 330 of the workflow diagram 300, the server includes a combiner module (e.g., combiner 142) configured to combine the PCA results Cⁱ (from the researchers) to provide aggregate PCA metadata Cⁱ 332. The aggregate PCA metadata Cⁱ 332 can be plotted in d-dimensions, shown at 334. The server 302 can further include a clustering module (e.g., clustering module 144) configured to classify respective users by population clusters and provide corresponding cluster data 338. In an example, the clustering module 336 uses the k-means clustering algorithm to determine the population cluster of each respective sample ID. Other clustering algorithms (e.g., fuzzy clustering, the CURE clustering algorithm, an expectation-maximization algorithm, etc.) can be used by the clustering module in other examples. The server 302 can also be configured to determine the number of clusters (populations) that are to be detected in the aggregate PCA metadata 332 and 334, such according to the Elbow method or another approach (e.g., information criterion or cross-validation). The Elbow method works by initially plotting the explained variation in within-cluster sum of squares (WCSS) as a function of the number of clusters, and then picking the number of clusters that corresponds to the elbow in the plot as the optimal number. Finally, the server sends the cluster data to the researchers. The cluster data can include (i) a population cluster identifier (e.g., a descriptor or label) for each sample, and (ii) the size of each cluster (e.g., the number of individuals that each cluster contains). The researchers can perform further analysis of the respective datasets based on the cluster data 338.

In summary, to identify population substructure across multiple researchers' datasets, each researcher provides some metadata to the server. The server is able to identify all the populations and label to which population each individual belongs. Based on the received metadata, the server determines the population cluster of each individual in the federated dataset of all researchers. Depending on the study the researchers are conducting, they may decide to keep only the individuals that belong to the largest population in their combined dataset or the ones that belong to the smallest population.

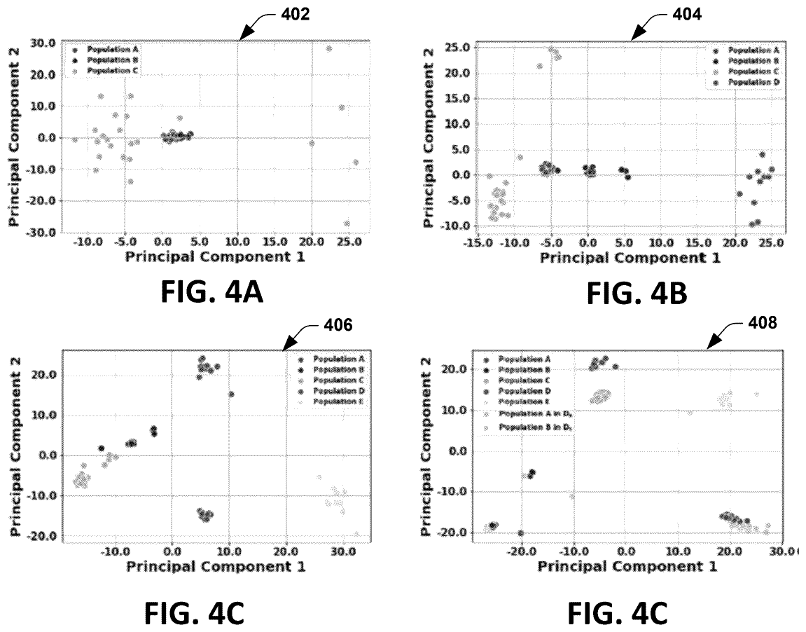

FIGS. 4A, 4B, 4C, and 4D depict plots 402, 404, 406, and 408 of combined PCA outputs generated (e.g., by combiner 142, 332) for a PCA model (e.g., model 124, 216, 310) that has been trained based on datasets D^{s} having different numbers of populations. In each of the plots 402, 404, 406, and 408, it is assumed that the data sets D^{a} and D^{b} include samples belonging to populations A and B. The populations in D^{s} (used to train the PCA model) include: in plot 402, only population C; in plot 404, populations C and D; in plot 406, populations C, D, and E; and in plot 408, populations A, B, C, D, and E. FIGS. 4A, 4B, 4C, and 4D demonstrate that the performance (accuracy) of the framework described herein increases as the number of different populations increases in D^{s}, (ii) the performance (accuracy) of the framework achieves the benchmark accuracy when D^{s} includes more than two different populations, and (iii) even when the trained PCA model on D^{s} does not fully represent all locally observed populations, we high accuracy can still be achieved.

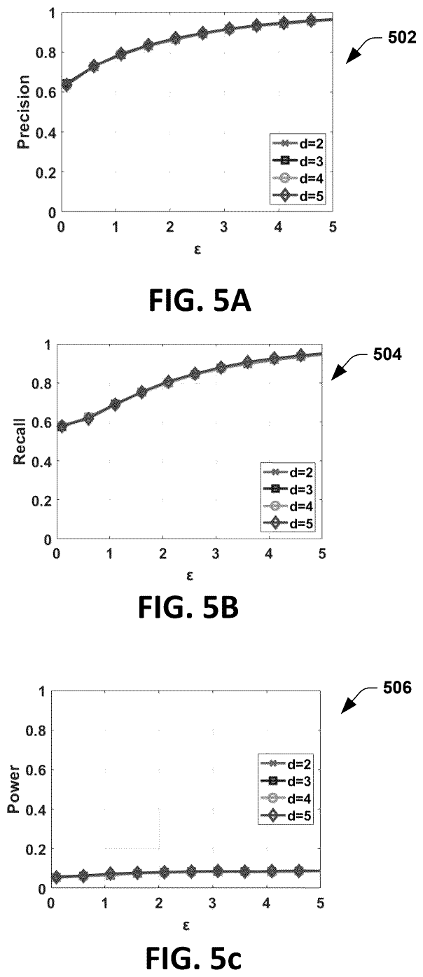

FIGS. 5A, 5B, and 5C are plots 502, 504, 506 depicting precision, recall, and power, respectively, for an example privacy-preserving framework. FIGS. 5A, 5B, and 5C demonstrate a scenario when datasets D^{a} and D^{b} each contain only one type of population each (different from each other). As e increases (i.e. the amount of noise added decreases), and the framework can achieve higher utility values, but at the same time, we observe higher power values for membership inference as well. For an example where ξ=3 and k=3, a precision and recall of almost 1, and a power of 0.2 can be achieved.

As the number of clusters (k) in the k-means clustering algorithm (e.g., implemented by clustering module 144, 336) increases from 2 to 3, utility in terms of both precision and recall increases. This shows that the framework described herein has better performance when the selected number of clusters is close to the optimum. It has also been determined that the power keeps increasing for larger e values and the power reaches 1 for ξ=∞. Additionally, it has been determined the results for different number of dimensions d were very similar in terms of both utility and membership inference power, and for most of the ϵ values, the utility and power values were almost identical. Moreover, it can be shown that the privacy risk of the proposed scheme is lower than the risk posed due to sharing of GWAS statistics.

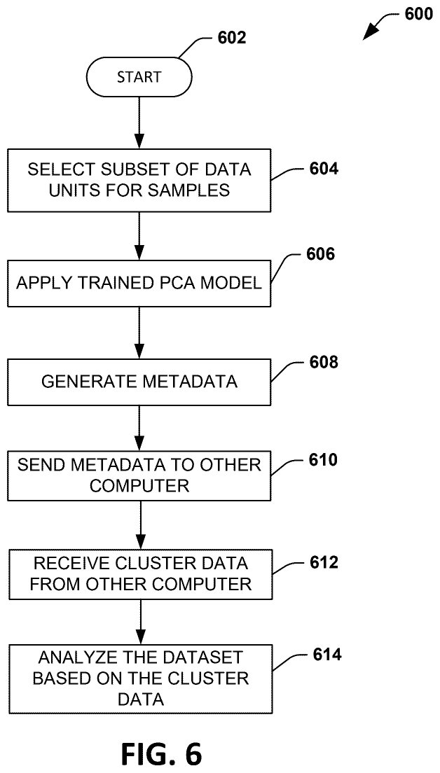

FIG. 6 is a flow diagram 600 depicting an example method to preserve privacy for collaborative data analysis. While, for purposes of simplicity of explanation, the method 800 of FIG. 6 is shown and described as executing serially, it is to be understood and appreciated that such methods are not limited by the illustrated order, as some aspects could, in other examples, occur in different orders and/or concurrently with other aspects from that disclosed herein. Moreover, not all illustrated features may be required to implement a method. The methods or portions thereof can be implemented as instructions stored in one or more non-transitory machine readable media and be executed by a processor of one or more computer devices (e.g., computer 102, 104, 106), for example, to cause the processor to perform the method. The method 800 can be implemented according to the systems described herein. Accordingly, the description of FIG. 6 can refer to certain aspects of FIGS. 1, 2, and 3. For simplicity, the method 600 is described from the perspective of a given user (e.g., researcher) and a corresponding instance of the method can be implemented in parallel by each other user with which the given user is collaborating.

The method 600 begins at 602, which can include initiating collaboration between two or more users (e.g., researchers). This can include authorizing such collaboration within a federated system (e.g., managed by server 106), such as responsive to user inputs by the collaborating users. Communication between such users can be encrypted and/or occur through a secure channel, for example.

At 604, the method includes selecting (e.g., by data selector 204) a subset of data units in each of a plurality of samples stored in a dataset. As described herein, each sample of the plurality of samples stored in the dataset includes a respective plurality of data units. In some examples, the subset of data units can include a subset of SNPs.

At 606, the method includes applying a trained model (e.g., a trained PCA model) to the selected subset of data units in the samples of the first dataset to provide a PCA output. For example, model deployment module 218 (or metadata generator, more generally) can apply a trained model (e.g., model 124, 216, 310) to the local data set (e.g., dataset 126, 210) to provide PCA output 226, such as described herein.

At 608, metadata is generated based on the model output. In some examples, the metadata generation at 608 can include introducing noise into the model output (e.g., by noise adder 220, 322, 324) and/or obfuscating user IDs (e.g., by ID obfuscation module 222), such as described herein. For example, the generation of metadata at 608 can be implemented as part of workflow stage 316, such as described herein.

At 610, the method includes sending the metadata (e.g., from the given user's computer 102, 104, 304, 306) to another computer (e.g., server 106, 302) through a communications link. At 612, the method includes receiving (e.g., at the given user's computer from the server) cluster data from the server. For example, cluster data (e.g., 146, 338) can be generated by a shared resource (e.g., server 106, 302) in the framework based on aggregating and clustering of metadata (e.g., generated at 608) from multiple collaborating researchers. The cluster data can identify populations for each of the samples in the datasets as well as indicate the number of samples in each cluster, such as described herein. The sending and receiving at 610 and 612 can be implemented as part of an outsourcing stage (e.g., workflow stage 316) by outsourcing module 120.

At 614, the method 600 includes analyzing data based on the cluster data. For example, the samples in the respective datasets at 614 can be filtered (e.g., by filter module 122) by removing or retaining a subset of samples from the data samples stored in dataset to provide a filtered subset of the data samples based on the cluster data (at 612). The analysis of the data samples can include analyzing genetic information represented in the filtered subsets of the samples (e.g., samples from the respective federated datasets). This can include analyzing data records for samples categorized in one or more identified clusters based on the cluster data. Also, or alternatively, the analysis can include selecting samples according to the size of the respective clusters to which the samples belong, which can also be specified by the cluster data.

### Example Embodiments

Several aspects of the present technology are set forth in the following numbered examples.

Example 1. A method comprising:
generating, on or by a first computer, first metadata based on applying a trained model to a plurality of samples stored in a first dataset, in which each sample of the plurality of samples stored in the first dataset includes a plurality of data units, and the first metadata includes features having a reduced dimensionality from the first dataset and representing variations and/or patterns in the first dataset according to the trained model;
generating, on or by a second computer, second metadata based on applying the trained model to a plurality of samples stored in a second dataset, in which each sample of the plurality of samples stored in the second dataset includes a plurality of data units and the second metadata includes features having a reduced dimensionality from the second dataset and representing variations and/or patterns in the second dataset according to the trained model;
sending the first metadata to a third computer through a first communications link;
sending the second metadata to the third computer through a second communications link;
combining, by the third computer, the first metadata and the second metadata to provide aggregate metadata representing samples of the first dataset and the second dataset;
classifying, by the third computer, the samples into respective clusters based on the aggregate metadata and providing cluster data identifying respective samples in each of the respective clusters; and
sending the cluster data to each of the first computer and the second computer.
   Example 2. The method of example 1, wherein the trained model comprises a trained principal component analysis (PCA) model, wherein the features of the first metadata comprise first eigenvectors, and the features of the second metadata comprise second eigenvectors.
   Example 3. The method of example 2, further comprising training, by the third computer, the trained PCA model based on third dataset such that the trained PCA model is adapted to capture population clusters for the samples in the first dataset and the second dataset.
   Example 4. The method of example 1,
wherein generating the first metadata further comprises adding noise to each of the features of the first metadata, and
wherein generating the second metadata further comprises adding noise to each of the features of the second metadata.
   Example 5. The method of example 4,
wherein each of the features of the first metadata has a respective sensitivity defined by the trained model, and
wherein the noise added to the features of the first metadata comprises Laplacian noise that is added to each of the features of the first metadata based on the respective sensitivity thereof.
   Example 6. The method of example 1, wherein each of the samples of the first dataset and each of the samples of the second dataset has a unique identifier, and prior to the method further comprises:
obfuscating, on or by the first computer, the unique identifier for each of the samples of the first dataset; and
obfuscating, on or by the second computer, the unique identifier for each of the samples of the second dataset.
   Example 7. The method of example 1, wherein the respective clusters define population clusters for individuals represented by the samples in the first dataset and the second dataset, and the cluster data comprises identifiers for at least some of the samples in the first dataset and the second dataset.
   Example 8. The method of example 1, wherein each of the data units includes a single nucleotide polymorphism (SNP) of a multitude of SNPs in each of the samples.
   Example 9 . . . . The method of example 8, further comprising:
selecting, on or by the first computer, a proper subset of the SNPs in each of a plurality of samples stored in the first dataset; and
selecting, on or by the second computer, a proper subset of the SNPs in each of a plurality of samples stored in the second dataset.
   Example 10. The method of example 1, further comprising:
removing or retaining a subset of samples from the first dataset based on the cluster data to provide an updated first dataset; and
removing or retaining a subset of samples from the second dataset based on the cluster data to provide an updated second dataset.
   Example 11. A method comprising:
selecting, on or by a first computer, a subset of data units in each of a plurality of samples stored in a first dataset, in which each sample of the plurality of samples stored in the first dataset includes a respective plurality of data units;
applying, on or by the first computer, a trained principal component analysis (PCA) model to the selected subset of data units in the samples of the first dataset to provide a PCA output;
generating metadata based on the PCA output;
sending the metadata from the first computer to a second computer;
receiving cluster data at the first computer, in which the cluster data is determined by second computer to define a measure of relatedness among the samples in at least the first dataset based on the metadata from the first computer and other metadata from at least one other computer, and the measure of relatedness among the samples quantifies a similarity between samples based on the subset of data units for samples in the first dataset and a subset of data units for samples in at least one other dataset associated with the at least one other computer; and
removing or retaining a subset of samples from the first dataset based on the cluster data to provide an updated first dataset.
   Example 12. The method of example 11, wherein the PCA output includes a set of features based on the trained PCA model and the selected subset of data units in the samples of the first dataset, and
wherein the features have a dimensionality reduced relative to a dimensionality of the first dataset and represent variations and/or patterns in the first dataset according to the trained PCA model.
   Example 13. The method of example 12, wherein generating the metadata further comprises introducing noise to each of the features of the PCA output to provide the metadata.
   Example 14. The method of example 13, wherein each of the features has a respective sensitivity defined by the trained PCA model, and
wherein the noise introduced to each of the features of the PCA output comprises a Laplacian noise that is added to each of the features based on the respective sensitivity thereof.
   Example 15. The method of example 11, wherein the trained PCA model is trained based on third dataset sufficient to enable the trained PCA model to capture population clusters for the samples in the first dataset and the at least one other dataset.
   Example 16. The method of example 11, wherein each of the samples of the first dataset has a unique identifier and, prior to sending the metadata, the method further comprises:
obfuscating, on or by the first computer, the unique identifier for each of the samples of the first dataset.
   Example 17. The method of example 11, wherein each of the data units includes a single nucleotide polymorphism (SNP) of a multitude of SNPs in each of the samples.
   Example 18. The method of example 11, further comprising:
removing or retaining a subset of samples from the first dataset based on the cluster data to provide an updated first dataset for collaborative research with a user of the at least one other computer.
   Example 19. A system, comprising:
a first computer comprising:
   non-transitory memory to store instructions and data, in which the data comprises a first dataset that includes a plurality of samples, each sample including a plurality of data units; and
   one or more processors coupled to the memory, in which the instructions are executable by the one or more processors, the instructions comprising:
      metadata generator code to apply a trained principal component analysis (PCA) model to a selected subset of data units in the samples of the first dataset to provide a PCA output; and
      generate first metadata based on the PCA output; and
a second computer comprising:
   non-transitory memory to store instructions and data, in which the data comprises a first dataset that includes a plurality of samples, each sample including a plurality of data units; and
   one or more processors coupled to the memory, in which the instructions are executable by the one or more processors, the instructions comprising:
      combiner code to combine the first metadata and at least second metadata, which is associated with a second dataset, to provide aggregate metadata corresponding to samples of the first dataset and the second dataset;
      clustering code to classify the samples of the first dataset and the second dataset into respective clusters based on the aggregate metadata and provide cluster data identifying respective samples in each of the respective clusters; and
      code to send the cluster data to at least the first computer.
         Example 20. The system of example 19, wherein each of the data units defines a single nucleotide polymorphism (SNP) of a multitude of SNPs stored for each of the samples in the first dataset, and the instructions stored in the memory of the second computer are further programmed to generate the trained PCA model based on a third dataset having sufficient samples to enable the trained PCA model to capture population clusters for the samples in the first dataset and the second dataset, the system further comprising:
a third computer that provides the second metadata associated with the second dataset, wherein cluster data is also sent to the third computer.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a computer device.

Also, certain examples have been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the processor, cause the processor to implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Where the disclosure or claims recite “a,”, “an,” “a first,” or “another” element, or the equivalent thereof, it should be interpreted to include one or more than one such element, neither requiring nor excluding two or more such elements. As used herein, the term “based on” means based at least in part on. As used herein, the term “and/or” can include any and all combinations of one or more of the associated listed items.

As used herein, the term “includes” means includes but not limited to, the term “including” means including but not limited to what is listed. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What have been described above are examples of the disclosure. It is, of course, not possible to describe every conceivable combination of components or method for purposes of describing the disclosure, but one of ordinary skill in the art will recognize that many further combinations and permutations of the disclosure are possible. Accordingly, the disclosure is intended to embrace all such alterations, modifications, and variations that fall within the scope of this application, including the appended claims.

All references, publications, and patents cited in the present application are herein incorporated by reference in their entirety.

Having described the invention, we claim:

1. A method comprising:
generating, on or by a first computer, first metadata based on applying a trained model to a plurality of samples stored in a first dataset, in which each sample of the plurality of samples stored in the first dataset includes a plurality of data units, and the first metadata includes features having a reduced dimensionality from the first dataset and representing variations and/or patterns in the first dataset according to the trained model;
generating, on or by a second computer, second metadata based on applying the trained model to a plurality of samples stored in a second dataset, in which each sample of the plurality of samples stored in the second dataset includes a plurality of data units and the second metadata includes features having a reduced dimensionality from the second dataset and representing variations and/or patterns in the second dataset according to the trained model;
sending the first metadata to a third computer through a first communications link;
sending the second metadata to the third computer through a second communications link;
combining, by the third computer, the first metadata and the second metadata to provide aggregate metadata representing samples of the first dataset and the second dataset;
classifying, by the third computer, the samples into respective clusters based on the aggregate metadata and providing cluster data identifying respective samples in each of the respective clusters; and
sending the cluster data to each of the first computer and the second computer.

2. The method of claim 1, wherein the trained model comprises a trained principal component analysis (PCA) model, wherein the features of the first metadata comprise first eigenvectors, and the features of the second metadata comprise second eigenvectors.

3. The method of claim 2, further comprising training, by the third computer, the trained PCA model based on third dataset such that the trained PCA model is adapted to capture population clusters for the samples in the first dataset and the second dataset.

4. The method of claim 1,
wherein generating the first metadata further comprises adding noise to each of the features of the first metadata, and
wherein generating the second metadata further comprises adding noise to each of the features of the second metadata.

5. The method of claim 4,
wherein each of the features of the first metadata has a respective sensitivity defined by the trained model, and
wherein the noise added to the features of the first metadata comprises Laplacian noise that is added to each of the features of the first metadata based on the respective sensitivity thereof.

6. The method of claim 1, wherein each of the samples of the first dataset and each of the samples of the second dataset has a unique identifier, and prior to the method further comprises:
obfuscating, on or by the first computer, the unique identifier for each of the samples of the first dataset; and
obfuscating, on or by the second computer, the unique identifier for each of the samples of the second dataset.

7. The method of claim 1, wherein the respective clusters define population clusters for individuals represented by the samples in the first dataset and the second dataset, and the cluster data comprises identifiers for at least some of the samples in the first dataset and the second dataset.

8. The method of claim 1, wherein each of the data units includes a single nucleotide polymorphism (SNP) of a multitude of SNPs in each of the samples.

9. The method of claim 8, further comprising:
selecting, on or by the first computer, a proper subset of the SNPs in each of a plurality of samples stored in the first dataset; and
selecting, on or by the second computer, a proper subset of the SNPs in each of a plurality of samples stored in the second dataset.

10. The method of claim 1, further comprising:
removing or retaining a subset of samples from the first dataset based on the cluster data to provide an updated first dataset; and
removing or retaining a subset of samples from the second dataset based on the cluster data to provide an updated second dataset.

11. A method comprising:
selecting, on or by a first computer, a subset of data units in each of a plurality of samples stored in a first dataset, in which each sample of the plurality of samples stored in the first dataset includes a respective plurality of data units;
applying, on or by the first computer, a trained principal component analysis (PCA) model to the selected subset of data units in the samples of the first dataset to provide a PCA output;
generating metadata based on the PCA output;
sending the metadata from the first computer to a second computer;
receiving cluster data at the first computer, in which the cluster data is determined by second computer to define a measure of relatedness among the samples in at least the first dataset based on the metadata from the first computer and other metadata from at least one other computer, and the measure of relatedness among the samples quantifies a similarity between samples based on the subset of data units for samples in the first dataset and a subset of data units for samples in at least one other dataset associated with the at least one other computer; and
removing or retaining a subset of samples from the first dataset based on the cluster data to provide an updated first dataset.

12. The method of claim 11, wherein the PCA output includes a set of features based on the trained PCA model and the selected subset of data units in the samples of the first dataset, and
wherein the features have a dimensionality reduced relative to a dimensionality of the first dataset and represent variations and/or patterns in the first dataset according to the trained PCA model.

13. The method of claim 12, wherein generating the metadata further comprises introducing noise to each of the features of the PCA output to provide the metadata.

14. The method of claim 13, wherein each of the features has a respective sensitivity defined by the trained PCA model, and
wherein the noise introduced to each of the features of the PCA output comprises a Laplacian noise that is added to each of the features based on the respective sensitivity thereof.

15. The method of claim 11, wherein the trained PCA model is trained based on third dataset sufficient to enable the trained PCA model to capture population clusters for the samples in the first dataset and the at least one other dataset.

16. The method of claim 11, wherein each of the samples of the first dataset has a unique identifier and, prior to sending the metadata, the method further comprises:
obfuscating, on or by the first computer, the unique identifier for each of the samples of the first dataset.

17. The method of claim 11, wherein each of the data units includes a single nucleotide polymorphism (SNP) of a multitude of SNPs in each of the samples.

18. The method of claim 11, further comprising:
removing or retaining a subset of samples from the first dataset based on the cluster data to provide an updated first dataset for collaborative research with a user of the at least one other computer.

19. A system, comprising:
a first computer comprising:
non-transitory memory to store instructions and data, in which the data comprises a first dataset that includes a plurality of samples, each sample including a plurality of data units; and
one or more processors coupled to the memory, in which the instructions are executable by the one or more processors, the instructions comprising:
metadata generator code to apply a trained principal component analysis (PCA) model to a selected subset of data units in the samples of the first dataset to provide a PCA output; and
generate first metadata based on the PCA output; and
a second computer comprising:
non-transitory memory to store instructions and data, in which the data comprises a first dataset that includes a plurality of samples, each sample including a plurality of data units; and
one or more processors coupled to the memory, in which the instructions are executable by the one or more processors, the instructions comprising:
combiner code to combine the first metadata and at least second metadata, which is associated with a second dataset, to provide aggregate metadata corresponding to samples of the first dataset and the second dataset;
clustering code to classify the samples of the first dataset and the second dataset into respective clusters based on the aggregate metadata and provide cluster data identifying respective samples in each of the respective clusters; and
code to send the cluster data to at least the first computer.

20. The system of claim 19, wherein each of the data units defines a single nucleotide polymorphism (SNP) of a multitude of SNPs stored for each of the samples in the first dataset, and the instructions stored in the memory of the second computer are further programmed to generate the trained PCA model based on a third dataset having sufficient samples to enable the trained PCA model to capture population clusters for the samples in the first dataset and the second dataset, the system further comprising:
a third computer that provides the second metadata associated with the second dataset, wherein cluster data is also sent to the third computer.
